(19) United States
(12) Patent Application Publication
(10) Pub. No.: US 2003/0132913 A1
(43) Pub. Date: Jul. 17, 2003

(54) Touchless computer input device to control display cursor mark position by using stereovision input from two video cameras

(76) Inventor: Anton Issinski, Squamish (CA)

Correspondence Address: ANTON ISSINSKI, P.O. Box 1033, SQUAMISH, BC, V0N 3G0, CA

(21) Appl. No.: 10/042,364

(22) Filed: Jan. 11, 2002

(51) Int. Cl. G09G 5/08

(52) U.S. Cl. 345/158

(57) ABSTRACT

Computer peripheral touchless input device to control display cursor mark position by operator's finger located in the front of the display screen surface using stereovision input from two or more video cameras aimed along the screen surface. Cursor marker follows the operator's finger with a minimal spatial displacement providing a natural feeling of controlling marker position by the finger. The device further uses a translation velocity direction and an angular rotation speed of the finger to trigger equivalents of mouse buttons pressing and releasing events.

### BACKGROUND OF THE INVENTION

The present invention relates to computer peripheral input devices for allowing operator to control display cursor mark position and perform operations known as click events.

Modern computer operating systems require a peripheral input device capable of interacting with a graphical user interface, moving cursor marker along the screen workspace, clicking on displayed buttons or dragging graphical objects. Commonly known devices of such kind are computer mice for desktop systems or touchpads for portable computers.

While pressing physical keyboard buttons is a simple and obvious operation, using a computer mouse for graphical input requires some experience and takes additional operator's attention. This happens because the number of reasons.

First, the mouse is usually located and moved along the horizontal computer desk surface, while the computer display screen that displays the manipulated objects and provides visual feedback of the user's actions normally stands vertically in the front of the operator and away from the mouse. This spatial displacement, navigation in the orthogonal planes and a different scale between the display's screen and the mouse navigation area are the first type of inconvenience in operating the mouse.

The second problem is also a result of the displacement between the mouse and the display screen. Each time before starting cursor manipulation, operator has to locate the mouse or the touchpad sensor, position the cursor marker at the desired place on the screen and only then perform the required graphical input operation.

Touchscreen systems are free from those disadvantages but may cause screen contamination and wearing. They also may be not very accurate without using special stylus.

These problems can be overcome by introducing peripheral graphical input device that has reduced displacement between display cursor marker and operator's hand manipulated in the region near and parallel to the screen surface.

### BRIEF SUMMARY OF THE INVENTION

In the present invention the stereovision input from two video cameras is used to measure the position of the operator's finger and to move the cursor marker to the place on the screen where the finger is located. The same video cameras are used to measure the finger's movement direction and angular rotation speed to produce events interpreted by operating system as mouse left and right button click events.

Having the same type of functionality, this device can provide the same software interface as conventional mouse device does and hence may be installed on modern computers without expensive operating system modifications.

### BRIEF DESCRIPTION OF THE DRAWINGS

FIG. 1 is a front view of the computer display with mounted video cameras (1a), (1b) on the top of it and the cursor marker (3) displayed on the screen (2).

FIG. 2 is the left side view of the said display and the region (4) in the front of it.

FIG. 3 is a top view of the said display and the region (4) in the front of it.

FIG. 4 is a schematic perspective view of the said display and the pointing subject (5) located in the said region (4).

FIG. 5 is a schematic illustration of the pointing subject projected coordinates (6) definition.

FIG. 6 is an illustration of the pointing subject translation velocity vector (8), vector orthogonal to the screen surface (7) and an angle (α) between them definitions.

FIG. 7 is an illustration of the pointing subject angular rotation speed (9) definition.

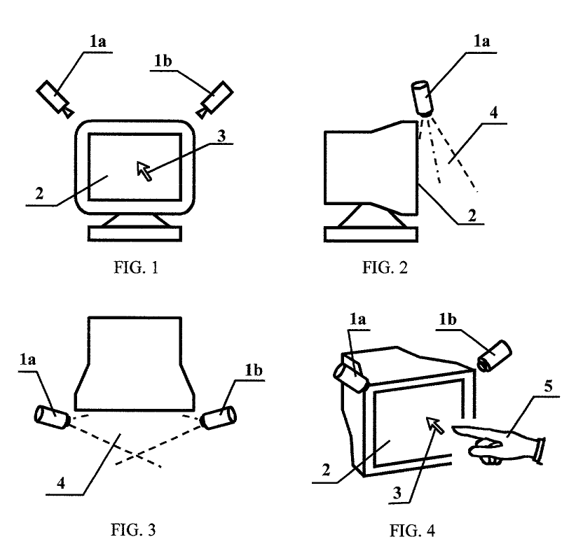

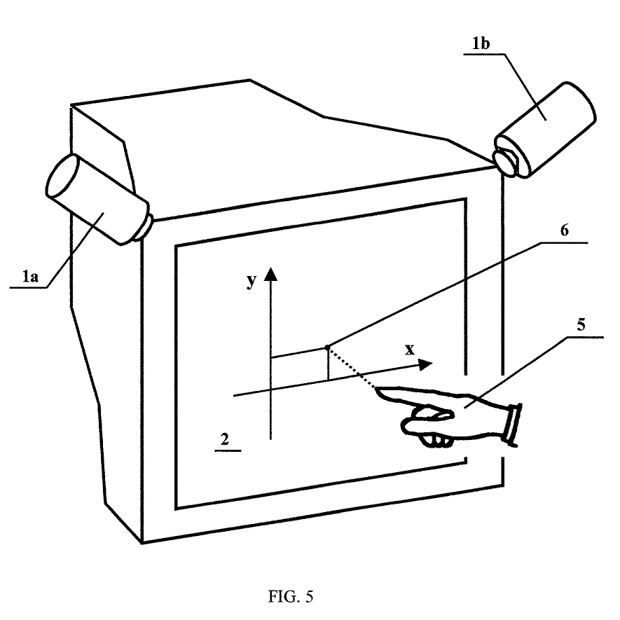

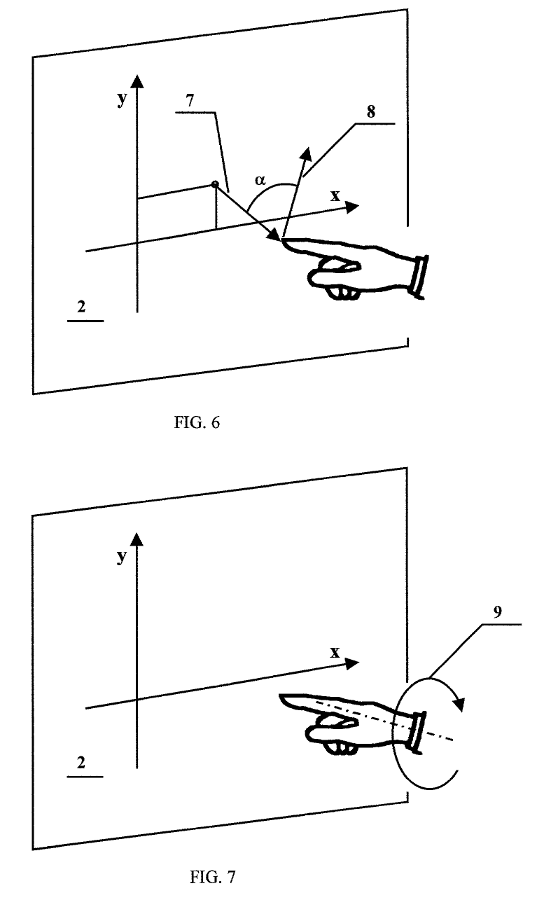

### DESCRIPTION OF THE INVENTION

The device described in the present invention consists of the following logical parts:

(A) Obtaining 2D coordinates of the pointing subject (5)—further referenced as a pointer—in the 2D display screen surface space.

(B) Means for sensing and triggering mouse left and right buttons clicking events.

(C) Means to communicate that data to the operating system of the computer controlling the display screen (2).

Part (A) is implemented as the following:

There are several video cameras mounted in the space adjacent to the display screen having their optical axis parallel or about to the screen plane. That cameras are taking images of the scenes in the front of the display and further sending said images, further also referenced as frames, to the processing unit. In some situations, when said video cameras are mounted close to the screen itself, there could be a distortion or focusing problems for images of the pointer when it is too close to one of the cameras. In that case having three or more video cameras will solve this problem because there always will be at least two cameras far enough from the pointer to take appropriate images. Having more then two cameras also improves an accuracy of the measured coordinates of the pointer.

The second step for the part (A) is to recognize the pointer in the each frame obtained from the video cameras. It can be done by a number of ways. The most obvious is to find the difference between several frames taken by the same camera at the different time and consider the difference to be an image of the moving pointer. The second way is to store the image of the pointer, say as a part of the adjustment or installation process and then locate this image in the frames coming from cameras in the real time. As usual, the combination of methods will give the best result: accumulating and adjusting of the image of the pointer taken from the real-time frames would be more precise and flexible.

The third step of the part (A) is to calculate 2D projected coordinates (6) of the pointer. First, the linear (1-dimensional) coordinates of the pointer should be obtained for each frame. It can be done by, for example, taking the coordinate of the pixel of the pointer image nearest to the screen surface or by more precise methods as calculating the middle of the pointer, its direction, etc. The second is to convert obtained set of two or more—the number is equal to the number of used video cameras—1D coordinates from each camera into 2D coordinates in the screen space, the method of doing so is commonly referenced as a stereo geometry method. The positions and angles of video cameras should be known—by for example, calculating them at the calibration process. This step completes the description of the part (A) of the invention.

Part (B) of the invention provides means for implementing in the device an events trigger that can be interpreted by the operating system as standard mouse ‘clicking’ events.

In order of the invented device to be complete emulation of the standard mouse, there should be means for the user to trigger two types of events: a mouse left button click event and a mouse right button click event. The left button click event is usually associated with pressing GUI buttons and the right mouse button click event is associated with properties request. Hence, it would be natural to consider pointer approaching the screen user action as the left mouse button push event and pointer moving away from the screen as the button release event. Further, there is another type of event ready to be recognized by the set of video cameras. It is the rotation of the pointer, which can be interpreted as the required right mouse button click event.

Part (C) of the invention provides a cost effective way to install this device into the existing environment of computers and operating systems. Most of cursor manipulators like mice or touch pads communicate the user's actions by means of interface, known as a mouse driver interface. Because the invented device provides at least the minimal set of functionality required by mouse driver interface, it can be implemented as a part of it.

What is claimed is:

1. Computer peripheral input device to control display cursor mark position by a pointing subject comprising
(a) a computer display screen (2)
(b) a region (4) in the front of the said display screen surface where the pointing subject (5) is to be navigated
(c) two or more video cameras (1a)-(1b) taking images of the said region (4)
(d) means for calculating two projected coordinates (6) of the pointing subject (5) in the two-dimensional display screen surface space by stereovision geometry methods for a set of two or more images of the same scene taken at the same time from different view points received from the said video cameras
(e) a display cursor marker or its operating system functional equivalent (3)
(f) means for positioning said cursor marker (3) on the said display screen (2) at the obtained coordinates (6).

2. Computer peripheral input device of claim 1 further comprising
(a) means for determining a translation velocity of the pointing subject (5) by differential methods using two or more sets of video images taken at different time by the video cameras (1a)-(1b)
(b) means for triggering a computer event when an angle (α) between the said velocity vector (8) and the vector (7) orthogonal to the display surface (2) falls into a predetermined diapason.

3. Computer peripheral input device of claim (2) where computer event (b) is further exposed to the computer software as a mouse button manipulation event.

4. Computer peripheral input device of claim 1 further comprising
(a) means for determining an angular rotation speed (9) of the pointing subject against an axis perpendicular to the display screen surface by differential methods using two or more sets of video images taken at different time by the video cameras (1a)-(1b)
(b) means for triggering a computer event when the said speed falls into a predetermined diapason.

5. Computer peripheral input device of claim (4) where computer event (b) is further exposed to the computer software as a mouse button manipulation event.

6. Computer peripheral input device of claim 1 where means (f) for positioning cursor marker include an operating system mouse driver interface.

7. Computer peripheral input device of claim 1 further comprising pointing subject recognition method comprising
(a) for an image obtained from one of the said video cameras (1a)-(1b) locating a sub-image area where the current image is different from one or more images taken by the same camera at the previous time
(b) further recognition of the pointing subject in the said located area of the current video image.

8. Computer peripheral input device of claim 1 further comprising pointing subject recognition method comprising
(a) accumulating images of the pointing subject
(b) further recognition of the pointing subject using said accumulated set of images (a).

9. Computer peripheral input device of claim 1 where the pointing subject (5) is the operator's finger.

10. Computer peripheral input device of claim 1 where one or more said video cameras are linear video cameras.

11. Computer peripheral input device of claim 1 further comprising a light source to illuminate pointing subject.

12. Computer peripheral input device of claim 1 where said computer display screen (2) is a display screen of a personal desktop computer.

13. Computer peripheral input device of claim 1 where said computer display screen (2) is a display screen of a personal portable computer.

14. Computer peripheral input device of claim 1 where said computer display screen (2) is a display screen of a workstation.

15. Computer peripheral input device of claim 1 where said computer display screen (2) is a display screen of a mainframe computer.

16. Computer peripheral input device of claim 1 where one or more said video cameras are webcams.
